(19) United States
(12) Patent Application Publication
(10) Pub. No.: US 2011/0247918 A1
(43) Pub. Date: Oct. 13, 2011

(54) SUBSTRATE DELIVERY DEVICE AND ALIGNER UNIT APPLIED THEREIN

(75) Inventors: Liang-Chung Hsu, Tainan (TW); Wu-Fu Ruan, Tainan (TW); Po-En Chien, Tainan (TW); Chung-Yueh Wu, Tainan (TW)

(73) Assignee: AURIA SOLAR, Tainan (TW)

(21) Appl. No.: 13/163,629

(22) Filed: Jun. 17, 2011

(30) Foreign Application Priority Data
May 6, 2011 (TW) 100115949

(51) Int. Cl. B65G 13/02; B65G 13/08; B65G 37/00

(52) U.S. Cl. 198/623

(57) ABSTRACT

A delivery device for delivering a substrate of a solar cell includes a plurality pairs of conveyer rollers arranged along a delivering path. Each pair of the conveyer rollers includes a first and second conveyer rollers respectively having first and second axes extending perpendicularly to the delivering path, and first and second aligners disposed circumferentially and respectively on the first and second conveyer rollers. The first and second conveyer rollers are made from polytethrafluoroethylene. The first and second aligners cooperatively define a carrier region for carrying the substrate thereon for delivery.

### CROSS-REFERENCE TO RELATED APPLICATIONS

This application claims the benefits of the Taiwan Patent Application Serial No. 100115949 filed on May 6, 2011, the entire contents of which are hereby incorporated herein by reference.

### BACKGROUND OF THE INVENTION

1. Field of the Invention

The present invention relates to an aligner unit and a substrate delivery device, and more particularly to a delivery device for delivering the substrate of a solar cell and the aligner unit applied in the delivery device.

2. Description of the Prior Art

Solar energy generally causes no environmental pollution and can be obtain from the sun in an ever-lasting manner. In order to solve the environmental pollution problem caused due to utilization of naturally found crude petroleum, natural gas and coal, and the latter are gradually in shortage or run out as days gone by. Since a solar cell can convert the solar energy directly into electrical energy, development and utilization of solar energy have drawn the great attention for the human beings.

During fabrication of the solar cell, a first electrode layer, a photovoltaic conversion layer and the second electrode layer are sequentially disposed on a glass substrate. Generally, during the fabrication process, the glass substrate is conveyed into a reaction chamber by means of a delivery device. A conventional delivery device includes several roller pairs arranged along a delivering path. To be more specific, the glass substrate is disposed on a carrier region defined between a pair of rollers. Each carrier region is further provided with a pair of aligners in such a manner that upon rotation of the rollers, the glass substrate is delivered along a predetermined path. Since the predetermined path for delivering the glass substrate into the reaction chamber is along a straight line, thus the glass substrate may collide against the aligners during the turning operation of the glass substrate and therefore maintains the colliding condition during the delivering process.

In addition, in order to prevent the aligners from being damaged owing to high temperature of the ambient environment, and to avoid chemical reaction of the dissolvent or gaseous substances from which the aligner is fabricated, the aligners in the conventional delivery device are made from stainless steel. Since stainless steel has a hardness or rigidity greater than that of the glass substrate, collision against the two during the delivering process causes cracks in the glass substrate, and the latter occasionally breaks up into pieces when passing under thermal stress. In other words, the production yield of the aligner is relatively low.

Due to the above-mentioned facts, the inventor of the present invention feels that there is a need to develop an aligner unit and a delivering device for delivering the glass substrate to its destination, such that no cracking is caused in the glass substrate due to lower hardness in the aligner with respect to the glass substrate. The aligner accordingly has a better chemical resistance under the high temperature of the ambient environment.

### SUMMARY OF THE INVENTION

Therefore, in the prior art technology, for delivering a glass substrate of a solar cell into different reaction chambers, a substrate delivery device is generally applied.

Since the delivering path for delivering the glass substrate into the respective reaction chamber inherently has some curve turnings, an aligner unit is usually provided in order to assist the curve turning operation of the glass substrate. Because fabrication of the solar cell is generally carried out under high temperature, there may be a lots of gas reaction so that stainless steel is used for construction of the aligner unit. However, the stainless steel possess the rigidity or hardness greater than that of the glass substrate, collision against the two during the delivering process causes cracks in the glass substrate, and the latter occasionally breaks up into pieces. In other words, the production yield of the aligner is relatively low.

In order to solve the aforesaid problems, the main object of the present invention is to provide a substrate delivery device and an aligner unit for adjusting the delivering path of the substrate, thereby preventing damage done onto the glass substrate during the delivery process.

The delivery device and the aligner unit provided according to the present invention is widely applied for delivering a substrate of a solar cell. The delivery device accordingly includes a plurality pairs of conveyer rollers arranged along a delivering path. Each pair of the conveyer rollers includes a first conveyer roller, a first aligner, a second conveyer roller and a second aligner.

The first conveyer roller has a first axis extending perpendicularly to the delivering path. The first aligner is disposed circumferentially on the first conveyer roller. The second conveyer roller is placed at one side of the d delivering path facing the first conveyer roller, and has a second axis extending perpendicularly to the delivering path. The second aligner is disposed circumferentially on the second conveyer roller. Each of the first and second aligners is externally coated with Teflon. The first and second aligners cooperatively define a carrier region for carrying the substrate thereon.

In one embodiment, the delivery device of the present invention further includes a plurality pairs of protection rings. Two protection rings are provided circumferentially on the first and second conveyer rollers within the carrier region and are respectively located interior of the first and second aligners.

In one embodiment, each of the first and second protection rings is made from fluorocarbon resin.

Preferably, each of the first and second aligners is externally coated with Teflon.

In one embodiment of the present invention, each of the first and second conveyer rollers is made from stainless steel.

Moreover, the first and second conveyer rollers are connected to with each other.

Alternately the first and second conveyer rollers are integrally formed with each other and are therefore in a one-piece cylindrical shape.

The aligner unit provided according to the present invention is applied in a substrate delivery device, which includes a plurality pairs of conveyer rollers. The aligner unit accordingly includes first and second aligners disposed circumferentially and respectively on external surfaces of first and second conveyer roller constituting a pair of conveyer rollers from the plurality pairs of the conveyer rollers. The materials for fabricating the first and second aligners include Teflon.

Preferably, each of the first and second aligners is externally coated with Teflon.

In one embodiment of the present invention, each of the first and second conveyer rollers is made from stainless steel.

As explained above, when compared to the prior art delivery device for delivering the substrate, the delivery device of the present includes an aligner unit coated with Teflon, which is adapted to resist high temperature and high thermal stress during the fabrication thereof and which causes no chemical reaction due to dissolvent or gaseous substance constituting the glass substrate. Since Teflon possesses the rigidity or hardness smaller than that of the glass substrate, there is no cracking caused in the glass substrate due to collision between the glass substrate and the respective aligner during the delivery process. In other words, the production quality of the glass substrate is enhanced.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a top planar view illustrating one embodiment of a delivery device of the present invention for delivering a substrate to a destination;

FIG. 2 shows a perspective view illustrating a conveyer roller employed in the delivery device of the present invention; and

FIG. 3 shows a perspective view illustrating a conveyer roller employed in another embodiment of the delivery device of the present invention.

### DETAILED DESCRIPTION OF THE PREFERRED EMBODIMENTS

The aligner unit and a substrate delivery device provided according to the present invention is widely applied in fabrication of solar cell assemblies so as to provide high yield in the production of the solar cell. Owing to different assembling types of the aligner unit and the delivery device, a few embodiments are illustrated in the following paragraphs.

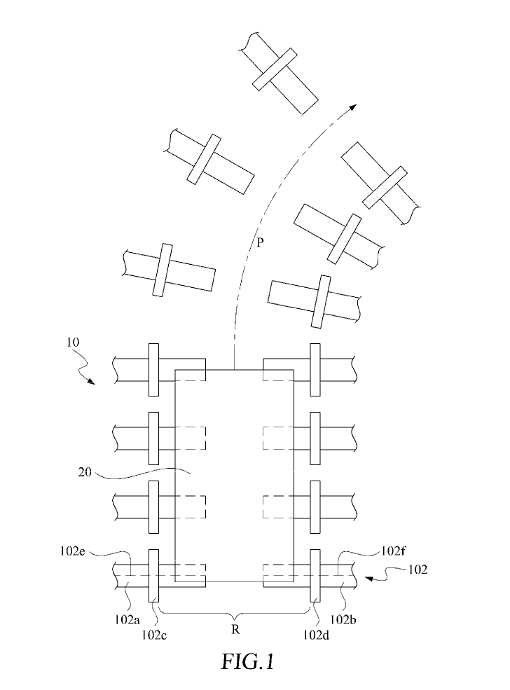

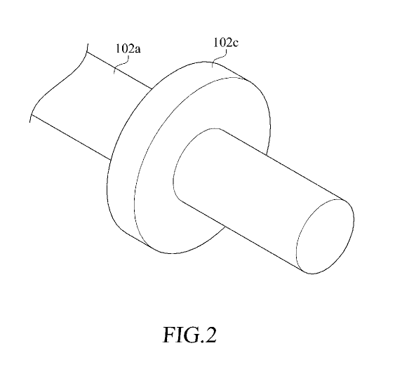

Referring to FIGS. 1 and 2, FIG. 1 shows a top planar view illustrating one embodiment of a delivery device of the present invention for delivering a substrate to a destination while FIG. 2 shows a perspective view illustrating a conveyer roller employed in the delivery device of the present invention shown in FIG. 1. As illustrated, the delivery device 10 of the present invention is installed within a reaction chamber for delivering the glass substrate 20 during fabrication of several types of solar cell. The delivery device 10 accordingly includes a plurality pairs of rollers 102 arranged along a delivering path P. Each pair of the conveyer rollers 102 includes a first conveyer roller 102a, a second conveyer roller 102b and an aligner unit consisting of at least a first aligner 102c and a second aligner 102d.

The first conveyer roller 102a and the second conveyer roller 102b have first and second axes 102e, 102f respectively extending perpendicularly to the delivering path P. The second conveyer roller 102b is located at one side of the delivering path P facing the first conveyer roller 102a, which is located at the other side of the delivering path P. The first and second conveyer roller 102a, 102b are made from materials, such as stainless steel, so as to avoid the chemical reaction caused due to the dissolvent or gaseous substance for fabrication of the solar cell and simultaneously prevent from being damage caused owing to high temperature of the ambient environment.

The first aligner 102c is disposed circumferentially on an external surface of the first conveyer roller 102a, and is made from polytethrafluoroethylene. The second aligner 102d is disposed circumferentially on an external surface of the second conveyer roller 102b, and is made from polytethrafluoroethylene. Preferably, each of the first and second aligners 102c, 102d is externally coated with Teflon. Moreover, the first and second aligners 102c, 102d cooperatively define a carrier region R for carrying the substrate, such as a glass substrate, thereon.

As described above, the glass substrate 20 is disposed over the carrier region

R such that upon rotation of the conveyer rollers 102, the glass substrate 20 is delivered along the delivering path P to its destination, during which, the glass substrate 20 collides against the first and second aligners 102c, 102d, which automatically and smoothly adjust or guide the glass substrate 20 in such a manner that the glass substrate 20 travels stably along the delivering path P during the turning direction of the glass substrate 20.

In addition, since the first and second aligners 102c, 102d are externally coated with Teflon, they can resist the high temperature during the fabrication thereof and there is no chemical reaction caused due to the dissolvent or gaseous substance from which the solar cell is fabricated. Because Teflon has a hardness smaller than that of the glass substrate, when the glass substrate 20 collides against the first and second aligners 102c, 102d, no cracking is caused in the glass substrate 20, thereby preventing damage of the glass substrate 20. In other words, the production quality of the glass substrate 20 is enhanced.

In this embodiment, the first and second aligners 102c, 102d are in circular-shaped. In other embodiment, the design of the first and second aligners 102c, 102d may have other structures, like rectangular, depending on the practical requirements.

In one aspect of the present invention, the first and second conveyer rollers 102a, 102b are connected securely to each other. Alternately, the first and second conveyer rollers 102a, 102b are integrally formed with each other and therefore are a one-piece cylindrical shape, as best shown in FIG. 2.

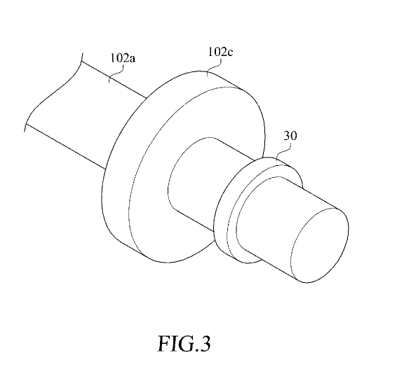

FIG. 3 shows a perspective view illustrating a conveyer roller employed in another embodiment of the delivery device of the present invention. This embodiment has the similar structure as the previous embodiment, except that the another embodiment further includes a first protection ring 30 disposed circumferentially on the first conveyer roller 102a interior to the first aligner 102c (only one is shown in FIG. 3) and a second protection ring 30 disposed circumferentially on the second conveyer roller 102b interior to the second aligner 102c such that once the glass substrate 20 is disposed on the carrier region R, the glass substrate 20 is prevented from directly contacting the first and second conveyer rollers 102a, 102b. In other words, collision of the glass substrate 20 against the first and second conveyer rollers 102a, 102b is prevented, and simultaneously ensuring stable delivery of the glass substrate 20 along the delivering path P towards the reaction chamber for fabrication of the solar cell. Preferably, each of the first and second protection rings 30 is made from fluorocarbon resin.

As described above, since the first and second aligners 102c, 102d are respectively coated with Teflon and since the latter possesses the rigidity or hardness smaller than that of the glass substrate 20, there is no cracking caused in the glass substrate 20 due to collision between the glass substrate 20 and the respective aligner during the delivery process. In other words, the production quality of the glass substrate 20 is enhanced.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A delivery device for delivering a substrate of a solar cell comprising:
a plurality pairs of conveyer rollers arranged along a delivering path, each pair of said conveyer rollers including
a first conveyer roller having a first axis extending perpendicularly to said delivering path,
a first aligner disposed circumferentially on said first conveyer roller and made from polytethrafluoroethylene materials,
a second conveyer roller placed at one side of said delivering path facing said first conveyer roller and having a second axis extending perpendicularly to said delivering path, and
a second aligner disposed circumferentially on said second conveyer roller and made from polytethrafluoroethylene materials;
wherein, said first and second aligners cooperatively define a carrier region for carrying the substrate thereon.

2. The delivery device according to claim 1, further comprising a first protection ring disposed circumferentially on said first conveyer roller interior to said first aligner and a second protection ring disposed circumferentially on said second conveyer roller interior to said second aligner.

3. The delivery device according to claim 2, wherein each of said first and second protection rings is made from fluorocarbon resin.

4. The delivery device according to claim 1, wherein each of said first and second aligners is externally coated with Teflon.

5. The delivery device according to claim 1, wherein each of said first and second conveyer rollers is made from stainless steel.

6. The delivery device according to claim 1, wherein said first and second conveyer rollers are connected to with each other.

7. The delivery device according to claim 6, wherein said first and second conveyer rollers are integrally formed with each other.

8. An aligner unit applied in a delivery device for delivering a substrate, the delivery device including a plurality pairs of conveyer rollers, the aligner unit comprising:
first and second aligners disposed circumferentially and respectively on external surfaces of first and second conveyer roller constituting a pair of conveyer rollers from the plurality pairs of said conveyer rollers, materials for fabricating said first and second aligners including Teflon.

9. The aligner unit according to claim 8, wherein each of said first and second aligners is externally coated with Teflon.

10. The aligner unit according to claim 8, wherein each of said first and second conveyer rollers is made from stainless steel.
